(19) United States
(12) Patent Application Publication
(10) Pub. No.: US 2026/0010496 A1
(43) Pub. Date: Jan. 8, 2026

(54) IDLE CHANNEL MARKING FOR PARTITIONED PROCESSOR COMMUNICATION

(71) Applicant: Groq, Inc., Mountain View, CA (US)

(72) Inventors: Dinesh Maheshwari, Fremont, CA (US); Benjamin Charles Serebrin, Sunnyvale, CA (US)

(21) Appl. No.: 19/257,892

(22) Filed: Jul. 2, 2025

Related U.S. Application Data
(60) Provisional application No. 63/666,972, filed on Jul. 2, 2024.
(60) Provisional application No. 63/673,345, filed on Jul. 19, 2024.

(51) Int. Cl. G06F 13/20

(52) U.S. Cl. CPC G06F 13/20; G06F 2213/40

(57) ABSTRACT

Systems and methods described herein provide for: generating a deterministic schedule defining operating states of a deterministic processor; determining, based on the deterministic schedule, an idle condition for a communication channel of the deterministic processor; configuring, based on the idle condition, the communication channel in an idle state; and suppressing a first uncorrectable error detected in data received over the communication channel while in the idle state.

### CROSS-REFERENCE TO PRIORITY APPLICATIONS

The present disclosure claims the benefit of priority to U.S. Provisional Application 63/666,972, titled “IDLE CHANNEL MARKING FOR CHIP-TO-CHIP PROCESSOR COMMUNICATION,” filed Jul. 2, 2024.

The present disclosure claims the benefit of priority to U.S. Provisional Application 63/673,345, titled “IDLE CHANNEL MARKING FOR CHIP-TO-CHIP PROCESSOR COMMUNICATION,” filed Jul. 19, 2024.

### FIELD

The present disclosure relates generally to processors, such as processors for processing tensors. More particularly, the present disclosure relates to idle channel marking for partitioned processor communication.

### BACKGROUND

A tensor is a family of mathematical structures that includes vectors, matrices and higher dimensional arrays. Tensors are used in many fields of science and engineering, and huge tensors with millions to billions of elements are used in numerical calculations such as machine learning. Tensor operations such as multiplication require huge amounts of processing power for large tensors.

Specialized processors for processing tensors have been developed in recent years. One type of a tensor processor is a tensor streaming processor (TSP), alternatively referred to as a language processing unit (LPU), such as TSPs/LPUs sold by Groq Incorporated. Tensor streaming processors and language processing units may comprise a two-dimensional array of functional units (e.g., tiles) organized into a plurality of slices. Each slice is configured to perform specific functions within the processor. Data may flow across the tiles in a first dimension across lanes. Instructions may flow across tiles in a second dimension across slices.

### SUMMARY

Aspects and advantages of embodiments of the present disclosure will be set forth in part in the following description, or can be learned from the description, or can be learned through practice of the embodiments.

In some implementations, the present disclosure provides a method. The method can include generating a deterministic schedule defining operating states of a deterministic processor. The method can include determining, based on the deterministic schedule, an idle condition for a communication channel of the deterministic processor. The method can include configuring, based on the idle condition, the communication channel in an idle state.

In some implementations, the present disclosure provides a computing system. The computing system can include one or more processors and one or more non-transitory, computer-readable media storing instructions that, when implemented, cause the one or more processors to perform. The operations can include generating a deterministic schedule defining operating states of a deterministic processor. The operations can include determining, based on the deterministic schedule, an idle condition for a communication channel of the deterministic processor. The operations can include configuring, based on the idle condition, the communication channel in an idle state.

In some implementations, the present disclosure provides one or more non-transitory, computer-readable media storing instructions that, when implemented, cause one or more processors to perform. The operations can include generating a deterministic schedule defining operating states of a deterministic processor. The operations can include determining, based on the deterministic schedule, an idle condition for a communication channel of the deterministic processor. The operations can include configuring, based on the idle condition, the communication channel in an idle state.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a diagram of a system according to example aspects of the present disclosure.

FIG. 2 illustrates a diagram of a system according to example aspects of the present disclosure.

FIG. 3 illustrates a diagram of a system according to example aspects of the present disclosure.

FIG. 4 illustrates a diagram of a system according to example aspects of the present disclosure.

FIG. 5 illustrates a diagram of a system according to example aspects of the present disclosure.

FIG. 6 illustrates a diagram of a system according to example aspects of the present disclosure.

FIG. 7 illustrates a diagram of a network according to example aspects of the present disclosure.

FIG. 8 illustrates a flowchart diagram of a method according to example aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Very-high speed processors are at the heart of the latest generation of artificial intelligence (AI) systems. Often, hundreds to thousands of such processors, such as the Tensor Streaming Processor (TSP) or Language Processing Unit (LPU) from Groq, Incorporated, can be used in a cluster to coordinate computations between processors. These clusters can utilize serial communication techniques, such as Chip-to-Chip (C2C) serial communication hardware and software, to efficiently and rapidly move data and instructions between processors. As used herein, a flow control unit or “flit” refers to a basic unit of data transmission in serial communication channels. For example, a 2-flit packet is a packet that consists of two flits. In some implementations, the first flit may be or include a header with routing information and the second flit may include data to be transmitted.

Despite significant improvements in communication technology, communication between processing units of processors can occasionally experience error conditions. For example, communication between processing units can be performed at such rapid speeds that noise and/or other sources of errors may not feasibly be entirely eliminated. Thus, communication approaches can employ error detection and correction techniques to provide for mitigation and continued operation even in the event of errors. Some error detection and correction techniques can provide for a first (e.g., smaller) number of errors within a given window to be corrected, providing for the restoration of non-erroneous data from the erroneous data, and a second (e.g., larger) number of errors to be detected even if correction of those errors is not possible using the correction technique.

As one example, orthogonal coding packets can be used in serial communication channels to improve the reliability and robustness of the data transmission of data and instructions. Orthogonal coding is a method of encoding data such that the correction algorithms are orthogonal to each other. For example, the codewords of the correction algorithm can be encoded to apply a two-layer correction process, where the outer layer of correction is resilient to various failure modes of the inner layer of correction. This can provide for the detection and correction of errors that may occur during transmission. Reducing errors in transmission can improve synchronization of processing units, as re-synchronization can be costly in terms of processing throughput and/or energy use. Furthermore, a set of flits where the data uses an orthogonal coding scheme can be referred to as an orthogonal coding packet. Other error correction techniques, such as Reed-Solomon error correction (RS), forward error correction (FEC), can also be utilized. For example, RS is a scheme that can provide for detecting two errors in a codeword for every one error in a codeword that can be corrected (e.g., where the number of correctable errors can be a design parameter). Symbols that are not important or do not need to be protected can be omitted from the FEC algorithm to prioritize error detection for more relevant symbols. This can be especially useful if a system has limited error correction resources.

One approach for error detection and correction includes a receiver unit that performs the error correction and detection of data prior to a functional unit operating on that data. Alternatively, a single functional unit may perform the error detection and correction operations as well as processing operations. The receiver unit can receive potentially erroneous data, correct any errors in the potentially erroneous data up to the first number of errors, and pass the corrected data to the processing unit for processing. If the data has additional errors that the receiver unit can only detect but not correct, then the receiver unit can send a flag or signal indicating that the data is uncorrectable. The uncorrectable signal can, for example, be used to initiate retransmission of the uncorrectable data and/or modify some operation of the system to attempt to resolve the source of errors, where possible. These operations can reduce the efficiency of processors. Furthermore, while errors may be configurable at a system (e.g., control-logic) level, the responsiveness of the control logic may be at a coarser time interval than the functional units themselves. This can provide for control-logic-level “squashing” of errors to be infeasible in some cases. For example, turning off erroneous faults at the control logic level may be on the order of microseconds while processing cycles of the functional units may be on the order of nanoseconds, amounting to several wasted cycles of computation. Therefore, it can be desirable to provide improved resilience to errors in systems.

Example aspects of the present disclosure can provide idle channel marking for partitioned processor communications. According to example aspects of the present disclosure, a processor can be divided into one or more functional units. The functional units can be arranged among a plurality of partitions. For example, in some implementations, each partition may correspond to a unique chip or substrate of the processor. The functional units can be configured as an ensemble that is distributed among the plurality of partitions. For example, the functional units can exchange information between the plurality of partitions to collectively perform operations, such as executing a program or process. As one example, a query or computing request (e.g., execution of a machine-learned model such as a token generation model) may be assigned to a “lane” of partitions. The query can move through the lane as each partition in the lane performs some operation on the data of the query. In this manner, a sizable number of queries may be processed independently and concurrently.

In one example implementation, the architecture of the processor can include a plurality of “tiles” (e.g., functional units) arranged into groups or “slices” with respect to the dedicated operation type (e.g., floating point/integer operations, load-store operations, network interfacing, etc.). These groups may be co-located on a particular partition and/or may be distributed among a plurality of partitions. For example, in one implementation, the processor can include partitions including M x N functional units that are chained together in a line, directed acyclic configuration, or other configuration. The partitions may generally be self-contained with respect to many processing operations, but may communicate via communication channels to convey data or instructions. For example, a first partition may perform some operations on data and then pass the data to a second partition (e.g., according to the linear or directed configuration). As one example, a plurality of partitions may be chained together using a connection protocol such as, for example, a peripheral component interconnect express (PCIe) bus or other similar interconnection technique. Communication circuits onboard the partition, such as chip-to-chip (C2C) circuits, can provide for multichip communications.

According to example aspects of the present disclosure, the processor can implement an error detection and correction (EDC) algorithm at communication channels between the plurality of partitions. The EDC algorithm can provide for correcting a first number of errors (e.g., bit or symbol errors) in signals transmitted over the communication channel. Furthermore, the EDC algorithm can provide for detecting uncorrectable errors in signals up to a second (e.g., greater) number of errors. Upon detection of an uncorrectable error, the processor can perform an error mitigation operation. As one example, the error mitigation operation can include raising a general fault signal. The general fault signal can, for instance, cause a complete reset of the processor and/or of data within the processor, and/or can signal the initiation of a handling sequence. While a general fault on some (e.g., non-idle) signal channels may be useful for handling truly unrecoverable errors, a general fault caused by errors on idle signal channels may be unnecessary and may lead to reduced processor efficiency. Furthermore, while the processor may be deterministic, error handling may not be deterministic in nature due to the unpredictability of error conditions. When one partition raises an error, that error may be propagated to other partitions and/or to control logic (e.g., a CPU or FPGA) such that the processor can be reset.

As one example, in some implementations, a physical coding sublayer (PCS) block can be located between core logic and serializer/deserializer (SerDes) receivers and transmitters can encode and decode data according to an encoding scheme. The PCS block can include error correction (e.g., FEC) to detect and correct errors in the data. The PCS block can further indicate when its error correction is unable to correct all potential errors. The system can, based on the indication from the PCS block, determine that a fault has occurred. In some implementations, an indication wire from the PCS block can be connected to internal logic for raising fault conditions.

The SerDes receivers and transmitters (referred to collectively as “SerDes component(s)”) can convert digital data into serial signals for transmission and/or convert the received serial signals back into digital data. The SerDes components can be used in high-speed data communication systems, such as those used in networking, telecommunications, and/or storage applications. The SerDes components can include several functions for preparing the data for transmission and/or to recover the data after it has been received. These functions can include, for example, clock and data recovery (CDR), equalization, and/or forward error correction (FEC). The CDR function can be used to recover the clock signal from the received data. This can be useful for accurately sampling and recovering the data. The equalization function can be used to compensate for any distortion or attenuation that may have occurred during the transmission of the data. The FEC function can be used to detect and correct errors in the data that may have occurred during transmission. The SerDes components may also include other features, such as support for different data rates and protocols, power management capabilities, and/or diagnostic and monitoring functions.

In some implementations, the SerDes components can convert between digital and analog signals. In some implementations, the SerDes component informs FEC logic when a symbol is in error in analog form.

Furthermore, example aspects of the present disclosure can employ deterministic processor scheduling, The deterministic processor scheduling can provide scheduled operations for the processor at each cycle. For example, in portioned communications, the deterministic processor scheduling can provide for scheduling cycles at which the communication circuits will send or transmit (Tx) or receive (Rx) data from other partitions, such as, for example, data packets, instruction packets, and so on. As used herein, deterministic data is data that follows a predictable or scheduled pattern or sequence. Deterministic data can be associated with a corresponding retrieval operation, which may colloquially be referred to as a “pop.” The system can verify that a retrieval operation corresponds to the correct data in the queue if the retrieval operation includes information about retrieved bytes and the on-chip memory or other component that manages the queue can determine whether the retrieved data was uncorrectable.

By contrast, nondeterministic data is data that does not follow a predictable pattern or sequence, and it may be subject to errors or corruption. Nondeterministic data can be handled (e.g., verified) in hardware through the use of acknowledgement (ack) and negative acknowledgement (nack) messages, as well as timeouts, to handle nondeterministic data. For instance, an ack message can be a signal that indicates that a data transmission was successful. Additionally, a nack message is a signal that indicates that a data transmission was unsuccessful. A timeout is a period of time during which the system waits for a response or acknowledgement before taking action. By using ack/nack/timeout messages in hardware, the system can handle nondeterministic data and ensure that it is properly transmitted and received.

According to example aspects of the present disclosure, communication channels, such as C2C serial communication channels, between chips of a partitioned processor can be marked as idle when data on the communication channel is extraneous, such as redundant or unnecessary (e.g., noise). Errors on idle communication channels (e.g., idle C2C serial communication channels) for partitioned processors (e.g., deterministic processors) can be ignored. Ignoring errors on idle channels can reduce disruptions in processor operations, thereby improving efficiency and synchronization. Additionally, ignoring errors on idle channels can provide for reduced power consumption. One example aspect of the present disclosure provides efficient error processing of orthogonal coding packets that improvedly provides for marking communication channels as idle. This, in turn, can provide for selectively ignoring errors on a packet-by-packet or similarly fine-grained basis. Ignoring errors on idle channels as described herein can provide for improved resilience of the processor to inevitable occasional errors.

The communication channels may present some data value at all times due to the nature of the processor communications. The communication channels may, for example, be electrically active when at least some portion of the processor is powered on. For example, even if the communication channel is unused, it may still be transmitting some value, such as a NO-OP packet. As one example, the processor may be configured in a sliding window configuration. In the sliding window configuration, a portion (e.g., a “window”) of the processor may be receiving instructions and/or performing operations at some time, while another portion outside the “window” of the processor may be idle. For example, communication channels in the idle portion may be sending and/or receiving NO-OP packets while the portion is idle. As another example, the communication channels may transmit only noise or other non-meaningful data. Furthermore, in some cases, due to the communication schema, typical data such as messages may be transmitted through the communication channel, but may be unnecessary to the operation of the processor. The communication channels may switch to transmitting (e.g., meaningful) operation instructions when the portion moves within the sliding window.

The present disclosure can provide for leveraging existing configurations within deterministic processors to mark communication channels as idle and thereby improving resilience of the processor. Example aspects of the present disclosure can leverage an existing encoding schema, such as a programmatic power/clock control encoding, to provide for the ICU to assign an idle condition to a receiving communication circuit. For instance, the deterministic nature of the deterministic processor can provide for scheduling the operations to be performed at each functional unit in the processor, including the communication circuits. This fine-grained determinism can provide for the capability to administer idle conditions among the communication circuits. For instance, the deterministic nature of the processor can provide for a scheduler to know which communication channels will be idle at each processor cycle.

According to some example aspects of the present disclosure, the programmatic power/clock control encoding can be used to provide for the ICU to indicate whether or not a receiver-side C2C communication channel will receive meaningful data or will be idle. When the communication channel is idle, uncorrectable errors in C2C flits will not cause general faults or other fatal errors, but may be silently discarded. For instance, according to one example encoding schema, when the communication channel is idle, all incoming messages may be treated as 2-flit messages. For instance, the communication channel may treat each incoming 2-flit message as an independent message, regardless of whether that message belongs to a larger set of packets (e.g., data packets). Treating incoming messages as 2-flit messages in the idle condition can provide for simplified processing of received data when in the idle mode, such as by avoiding a need to determine a length of each packet. This can additionally provide for avoiding dependencies on a packet header (e.g., indicative of packet length), which may be corrupted or otherwise unavailable in the idle condition. Furthermore, this can provide for a reduction in “false positive” conditions generated by an error on the communication channel during a time when the communication channel is transmitting non-meaningful data. Still further, by interpreting the packets as 2-flits, if either flit in one packet contains an error, the beginning of the next packet can easily be determined as the next 2-flit group. In some example encoding schema, this behavior can be useful where most packets are not relevant. However, it can be important to consider the behavior of several 2-flit packets of particular interest. In some example implementations, certain non-data packets such as sync packets and non-scheduled control and status register (CSR) packets may be handled differently from other packets, even in the idle condition.

First, receipt of software-controlled packets can effectively be disabled if those packets are not recognized or sent (e.g., by the transmit side). The software-controlled packets can be selectively enabled or disabled for partitions according to the idle status of channels in the partition. For example, orthogonal coding packets can effectively be disabled by not sending the packets via the Orthogonal Coding instructions on the transmit side. Therefore, to disable orthogonal coding packets in idle mode, the transmit side of a pair of partitions may not send packets using the orthogonal coding instructions. This can effectively disable the transmission of orthogonal coding packets when the receiver side is not configured to receive data in the idle mode. Disabling orthogonal coding packets in the idle condition can provide for a reduction in power consumption and complexity of the system amounting to the avoidance of potentially computationally intensive operations associated with the transmission and reception of orthogonal coding packets.

Additionally and/or alternatively, the communication channel can routinely transmit 2-flit “sync” packets to maintain synchronization between the partitions of the partitioned processor. The sync packets can include Hardware Adjusted Clock (HAC) values. The HAC values can be used, for example, to adjust an internal HAC offset used in synchronizing clock values between the partitions of the partitioned processor. As one example, the HAC can be synchronized across each of the partitions of the multipartition processor by incrementing a counter at each partition according to a time step, where the sync packets are utilized to synchronize the counters at each partition.

In some implementations of the present disclosure, the sync packets may be transmitted at a frequency that is significantly greater than a time step over which the HAC value increments. For example, several sync packets can be sent per time step. The HAC value may increment once per time step (e.g., at most once per time step) if a sync packet is received within the time step. The HAC values may also be used in a time adjustment loop that is slower than the time step over which the HAC value increments. In this manner, sync packets can be ignored when a communication channel is idle without negatively affecting synchronization of the partitions. For instance, the frequency at which a communication channel changes from idle to active can be frequent enough such that at least one sync packet is received within a time step over which the HAC value increments.

Additionally and/or alternatively, CSR packets can be transmitted. The CSR packets contain signals from the control logic that can be indicative of configurations and other parameters. The CSR packets may generally be nondeterministic. For instance, in some implementations, the CSR packets can be propagated through the system from the control logic to partitions, and from “parent” partitions to “child” partitions. For example, the system can be arranged in lanes where each partition has a “parent” directing back to the control logic (e.g., in a hierarchical structure) The system can be configured such that parent-facing communication channels (e.g., to receive data from parent partitions) are not idled. Additionally and/or alternatively, redundancy within the system (e.g., by broadcasting over multiple ports or channels) can provide for receiving CSR packets at a partition even if that partition includes idle channels. As another example, in some implementations, the control logic can send CSR packets over an idle channel only if the control logic additionally issues a read operation against the CSR value. This can ensure the corresponding write operation is not dropped. For example, if control software, a controller, etc. sends CSR traffic to an idle channel, it must also issue a read against the CSR value to ensure that the write was not dropped, as in idle mode packets may be silently discarded. By issuing a read against the CSR value, the controller or control software can verify that the write was properly received and that data in the write operation is not lost.

Additionally and/or alternatively, in some implementations, fault packets (e.g., general fault or “gfault”) packets can be transmitted. Fault packets can be indicative of some fault condition in the processor. For example, the values of bits in the fault packet can indicate which of a plurality of types of fault have occurred. For example, each bit position in the fault packet may respectively correspond to a type of fault. Additionally and/or alternatively, values of the bit in a bit position may respectively correspond to whether or not a fault has occurred. In an active condition, the receiver end of a communication channel can receive a fault packet, update a fault register at the partition based on the fault packet, and/or propagate the fault packet to other partitions. As one example, the fault packets can be used to update the fault register based on an OR operation between the bits of the fault packet and the bits of the fault register. The values in the fault register (e.g., after being updated by the OR operation) can be passed on as outgoing fault packets. In this manner, the fault packets can be idempotent. For instance, in some implementations, a plurality of N (e.g., where N is greater than one) fault packets can be communicated for a particular fault event. This can provide for tolerance up to N−1 corrupted or dropped packets. As one example, in some implementations, if a fault register includes values indicative of a fault, the partition can repeatedly communicate fault packets. By repeatedly sending out fault packets (e.g., periodically, at each clock cycle, etc.) the fault information will not be “lost” if it is received over an idle channel, and can be picked up once the idle channel becomes active again. Furthermore, redundant propagation can provide for other partitions to receive and propagate fault packets. Furthermore, in some implementations, sending multiple fault packets can be performed by a central core or processor. This approach could be implemented without significant hardware changes to the functional units themselves.

As one example, a reduced instruction set five (RISC-V) core unit can control one or more partitions of the processor. As one example, a tensor streaming processor or language processing unit can include a RISC-V or similar core unit as a controller. The core unit can be connected to a CSR ring for communication management. The core unit can receive and communicate fault packets directly with the partitions of the processor.

Referring now to error resilience, in some cases, analysis of Bit Error Rate (BER) for a large system assumes all communications channels are busy all the time. In the case where a channel is logically idle (from the perspective of the core logic), an uncorrected bit error on a NO-OP (No Operation) packet can be recoverable, as the packet can be discarded. For instance, in the case where a channel is logically idle (from the perspective of the core logic), no meaningful data may be transmitted, so the data, whether erroneous or not, can be discarded without significant impact on the system. Furthermore, in some implementations, suppression logic can suppress faults if an uncorrectable bit error is seen (e.g., by orthogonal coding) during idle times. For instance, the use of deterministic compilation and/or orthogonal coding, or other suitable techniques, can provide for the system to detect and correct bit errors and, if a bit error is detected, to suppress the fault at a core-logic level.

Referring now to the FIGS., example aspects of the present disclosure will be discussed in greater detail. It should be understood that aspects discussed in reference to one FIG. are expressly contemplated as being combinable with aspects of other FIGS. unless expressly indicated otherwise.

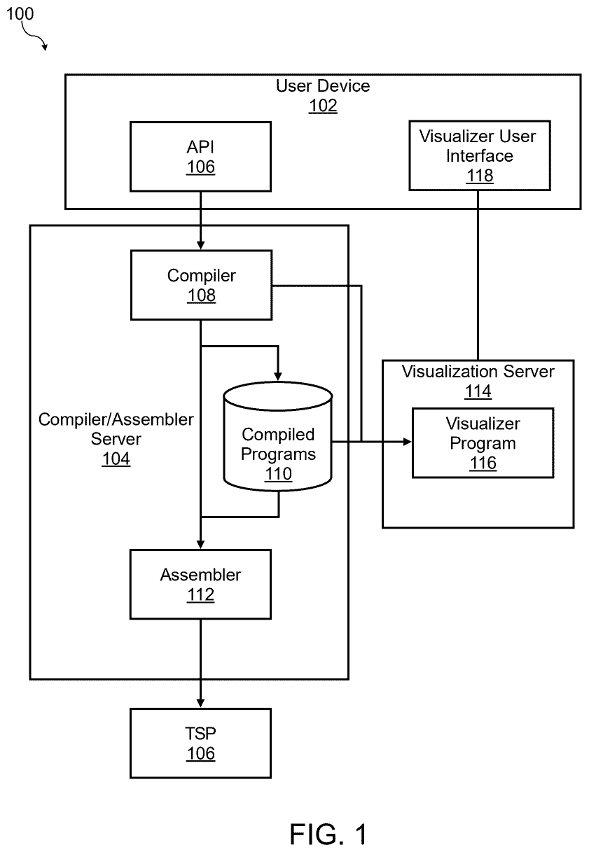

FIG. 1 illustrates a system 100 for compiling models to be executed on a tensor processor, according to an embodiment. The system 100 includes a user device 102, a server 104, and a processor 106. Each of these components, and their sub-components (if any) are described in greater detail below. Although a particular configuration of components is described herein, in other embodiments the system 100 may have different components and these components perform the functions of the system 100 in a different order or using one or more different mechanisms. For example, while FIG. 1 illustrates a single server 104, in other embodiments, compilation, assembly, and/or power usage functions are performed on one or more different devices. For example, in some embodiments, at least a portion of the functions performed by the server 104 are performed by the user device 102 and/or multiple servers.

The user device 102 comprises any electronic computing device (e.g., a personal computer, laptop, or workstation, and so on) which uses an Application Program Interface (API) 106 to construct programs to be run (e.g., executed) on the processor 106. The server 104 receives a program specified by the user (or other entity) at the user device 102 and compiles (e.g., via a compiler 108) the program to generate a compiled program 110 (or more than one compiled program). In some embodiments, the program is specified automatically, or dynamically, without manual input from one or more users.

In some embodiments, a compiled program 110 enables a data model for predictions that processes input data and makes a prediction from the input data. Examples of predictions include, but are not limited to, category classifications made with a classifier, or predictions of time series values. In some embodiments, the prediction model describes a machine learning model that includes nodes, tensors, and/or weights.

In one embodiment, the model is specified as a TensorFlow model, the compiler 108 is a TensorFlow compiler and the processor 106 is a tensor processor (e.g., a tensor streaming processor (TSP) or language processing unit (LPU)). In another embodiment, the prediction model is specified as a PyTorch model and the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, and so forth), tensors representing operands (e.g., values that the operators modify, such as scalar values, vector values, and matrix values, which may be represented in integer or floating-point format), and weight values that are generated and stored in the model after training. In some embodiments, where the processor 106 is a tensor processor having a functional slice architecture, the compiler 108 generates an explicit plan for how the processor will execute the program, by translating the program into a set of operations that are executed by the processor 106, specifying when each instruction will be executed, which functional slices will perform the work, and which stream registers will hold the operands. This type of scheduling is referred to as “deterministic scheduling.” This explicit plan for execution includes information for explicit prediction of excessive power usage by the processor when executing the program.

An assembler 112 receives compiled programs (e.g., the compiled program 110), generated by the compiler 108, and performs final compilation and channeling of the scheduled instructions to generate a compiled binary. In some embodiments, the assembler 112 maps the scheduled instructions indicated in the compiled program 110 to the hardware of the server 104, and then determines the exact (or most appropriate) component queue in which to place each instruction.

The processor 106, for example, is a hardware device with a significant number of matrix multiplier units that accepts a compiled binary assembled by the assembler 112, and executes the instructions included in the compiled binary. The processor 106 can include one or more blocks of circuitry for matrix arithmetic, numerical conversion, vector computation, short-term memory, data permutation and/or data switching. One such processor 106 is a tensor processor having a functional slice architecture. In some embodiments, the processor 106 comprises multiple tensor processors connected together.

The system 100 can further include a visualization server 114 that includes a visualizer program 116 for visualizing the deterministic operation of processor 106. The output of the visualizer program 116 can be displayed on a user interface, such as a Visualizer User Interface 118, for example. The visualization server 114 can be useful for debugging purposes.

When the TSP compiler receives a large model having more weights than the available memory on the TSP, the compiler is configured to determine how to allocate the model across the available TSP modules.

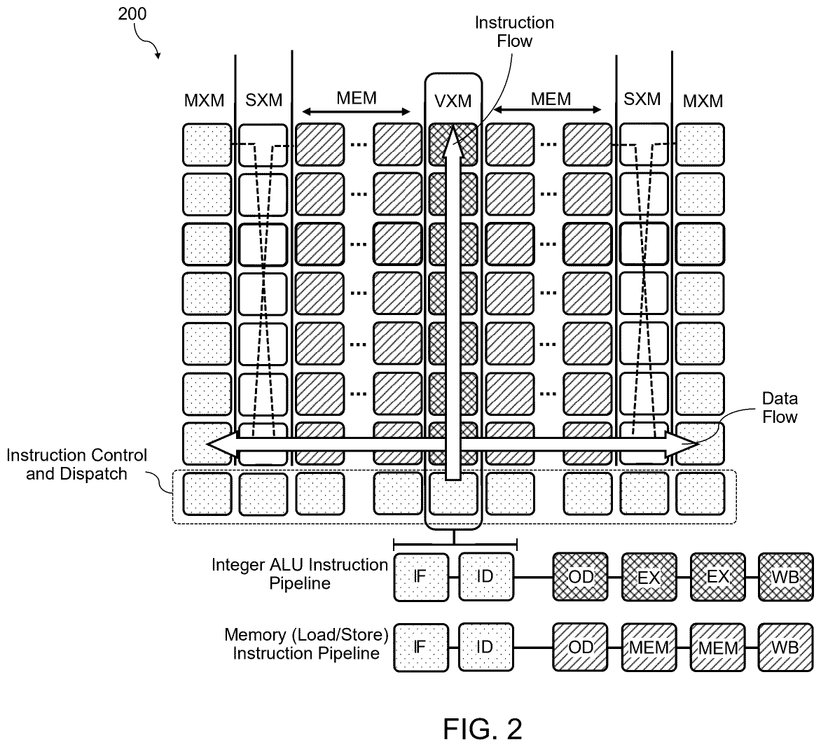

In accordance with embodiments of the present disclosure, the processor plane comprises a TSP (e.g., as may be commercially available from Groq, Inc.). It is to be understood that although many embodiments described herein use a TSP as the preferred processor, other deterministic processors may be used in commercial applications (or other types of applications) and the disclosed embodiments are not limited to a TSP implementation. FIG. 2 depicts an arrangement of functional slices in a TSP 200, in accordance with some embodiments.

Certain core architectural elements set the TSP apart from GPU and accelerators. In a conventional module multiprocessor (CMP), each “computational element” is an independent core that is interconnected using the on-chip network to exchange data between cores. Instruction execution is carried out over several stages, which can include: (i) instruction fetch (IF), (ii) instruction decode (ID), (iii) execution (EX) on Arithmetic Logic Units (ALUs), (iv) memory access (MEM), and (v) writeback (WB) to update the results in the general-purpose registers (GPRs).

In contrast from conventional multicore, where each computational element is a heterogeneous collection of functional units but globally homogeneous, the TSP inverts that to have a local functional homogeneity but module-wide (global) heterogeneity. Specifically, the TSP reorganizes the homogeneous two-dimensional mesh of cores into the functionally sliced microarchitecture depicted in FIG. 2. In this approach, each computational element implements a specific function and is stacked vertically into a specific “functional slice” in the Y-dimension of the two-dimensional on-chip mesh. The TSP disaggregates the basic elements of the conventional multicore per their respective functions: instruction control and dispatch (e.g., via instruction control unit (ICU)), memory (MEM), integer (INT) arithmetic, float point unit (FPU) arithmetic, and network (NET) interface, as depicted by the functional slice labels at the top of FIG. 2. Each row of the two-dimensional on-chip mesh contains a cross section of all functional slices.

In the organization depicted in FIG. 2, each functional slice is independently controlled by a sequence of instructions specific to its on-chip role. For example, the MEM functional slices support Read and Write, but not necessarily Add or Mul, which are typically performed in arithmetic functional slices (e.g., the vector execution module (VXM) and matrix execution module (MXM) functional slices) for some machine learning (ML) algorithms, such as a linear regression algorithm.

All (or nearly all) functional slice's computational elements execute the same instruction stream-Single Instruction Multiple Data (SIMD) instructions. Thus, the common instruction decodes, and dispatch logic can be factored out into its own computational element (e.g., ICU) and decompose the normal instruction execution pipeline into two areas: (i) instruction fetch, decode, and parceling and (ii) operand read, execute, and writeback. This approach decouples the memory subsystem from the functional units retrieving their operands and depositing results.

In some embodiments, each functional slice implements, for example, a 20-stage vector pipeline that spans the computational elements of each functional slice, with each computational element producing 16 elements of the 320-element maximum vector length. This type of processor organization naturally decomposes instruction flow in the vertical dimension, and data flow in the horizontal dimension as the data flow passes over different function types. With this processor organization, instruction execution is carried out by different computational elements: instruction fetching and decoding in the ICU and operand decode, execution and writeback at each computational element of the functional slice as the (vertical flowing) dispatched instruction intersects with the (horizontal flowing) operand data on which the dispatched instruction is operating. It will be appreciated that reference to ‘vertical’ and ‘horizontal’ or ‘north’, ‘south’, ‘cast’ and ‘west’ are used in connection with the illustrations shown in the Figures, are abstractions that are solely intended to aid the reader and should not be inferred as technical limitations.

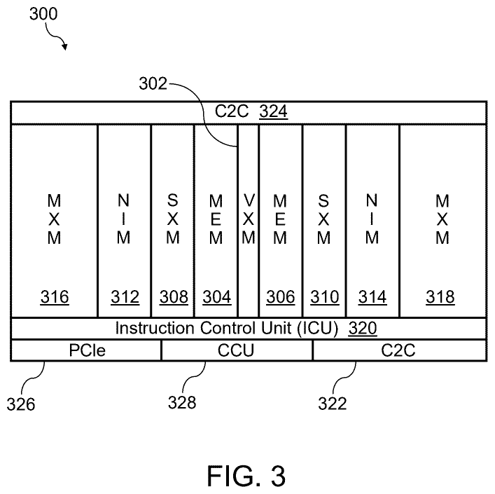

FIG. 3 illustrates an example TSP 300, in accordance with some embodiments. The TSP 300 can include memory and arithmetic units optimized for multiplying and adding input data with weight sets (e.g., trained or being trained) for machine learning applications (e.g., training and/or inference). For example, the TSP 300 includes a VXM 302 for performing operations on vectors (e.g., one-dimensional arrays of values). Other elements of the system (e.g., the TSP 300) are arranged symmetrically on either side of the VXM 302 to optimize processing speed. For example, the VXM 302 is adjacent to MEMs 304-306, SXMs 308-310 to control routing of data, data domain and presentation controllers (or numerical interpretation modules (NIMs)) 312-314, and MXMs 316-318. An ICU 320 controls the flow of data and execution of operations across blocks 302-318, for example. The TSP 300 may further include communications circuits such as chip-to-chip (C2C) circuits 322-324 and an external communication circuit 326 (e.g., peripheral component interconnect express (PCIe)). The TSP 300 may, for example, further include a TSP device control unit (CCU) 328 to control boot operations, clock resets, and other low level setup operations.

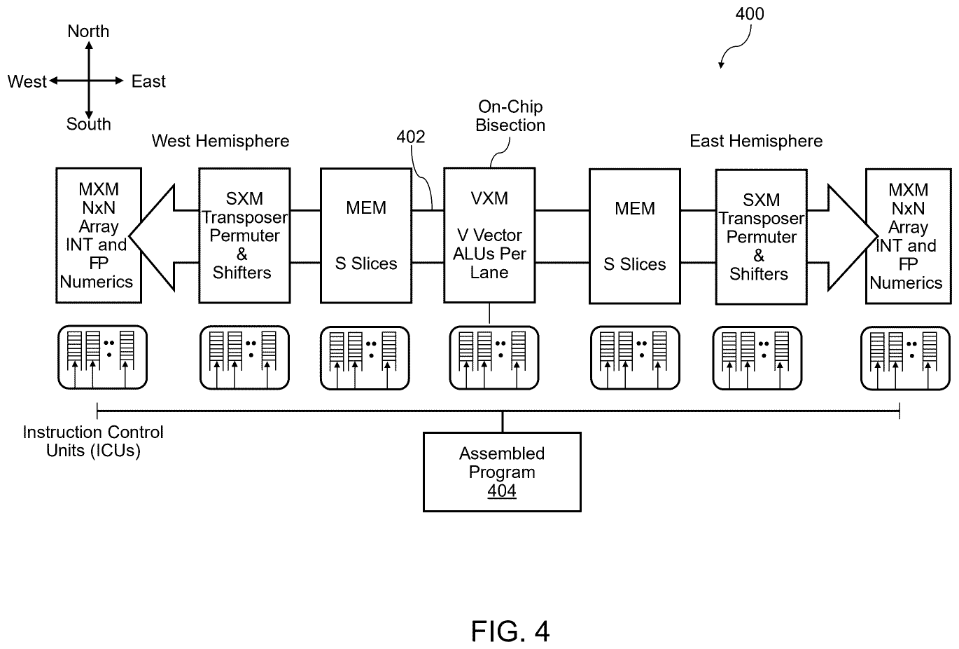

FIG. 4 illustrates organization and data flow within a row of a TSP architecture 400, in accordance with some embodiments. As depicted in FIG. 4, each row of the two-dimensional on-chip mesh of the TSP 400 contains a cross section of all functional slices, e.g., N×N array of MXMs configured for both integer (INT) and floating-point (FP) numeric (e.g., INT8 and FP16), S MEM functional slices, VXM functional slices with V vector ALUs per lane, and SXM functional slices. In this organization, each functional slice is independently controlled by a sequence of instructions specific to its on-chip role fetched by a corresponding array of ICUs. Conceptually, the functional slices are fixed and data 402 are flowing across their computational elements. As the data flows through a specific functional slice, each functional slice can optionally intercept the data operands and compute a result (e.g., in case of MXM and VXM), or move data between data transport lanes on the network (e.g., in case of SXM and MEM). Instructions flow northward from the ICUs to the functional slices, while data (operands and results) primarily flow east and west between functional slices. Any inter-lane data movement within a vector uses the on-chip network functional slice.

It is noted that the “east-west-north-south” directionality is provided herein for case of discussion and relativity. Furthermore, the “cast-west-north-south” directionality is used as a reference for explanation of processing flow as described herein and is not intended to be limited with respect to a label of a particular direction. For example, north-south could be reoriented to cast-west, and the principles currently described with east-west could apply to the reoriented north-south. In another example of the directionality not intended to be limited to the description per the reference noted, directionality could be referenced such that north-south is up-down and cast west is right-left and the principles would accordingly apply.

In one embodiment, 320 lanes are overlaid on the TSP 400 where each computational element in the on-chip mesh operates on, e.g., 16-lanes in a SIMD manner. The 16-lane unit can be referred to herein as a “superlane” and represents a cross-section of all the functional slices on the TSP device. As such, a superlane may represent the architecture's minimum vector length (min VL) of, e.g., 16 elements. Likewise, the vertical composition of 20 tiles forming a functional slice may produce a maximum vector length (max VL) of, e.g., 20×16=320 functional units. Each of the 144 independent on-chip ICUs can issue one or more instructions per clock cycle. The compiler has explicit control of a program order in each instruction queue, e.g., by generating an assembled program 404 for execution by the ICUs and functional slices. There can be N logical streams per lane for moving operands or results on-chip with, e.g., N/2 streams castward and N/2 streams westward. The globally shared SRAM may deliver a number of bytes per lane of stream bandwidth and low-latency access to model parameters. For example, MEM can read and MXM can install more than e.g., 100,000 weights into a 320×320 array (e.g., 320 lanes×320 functional units) in less than 30 clock cycles including SRAM and on-chip network transit delays.

As depicted in FIG. 2 and FIG. 4, the on-chip network is implemented as X-dim mesh and Y-dim mesh of computational elements with X-Y-X dimension order routing. Each instruction specifies the first hop direction (cast or west), so memory instruction semantics have both an address and a dataflow direction (see FIG. 4). Streams are routed in the X-dimension through MEM 304-306 and routed in the Y-dimension using the SXM's 308-310 permuter and lane-shifters to move data elements vertically. The SXM's 308-310 permuter implements a permutation function that is a mathematical technique that moves data elements in a software-specified 1:1 shuffle pattern.

The MEM 304-306 and the SXM 308-310 provide deterministic routing of stream data as the stream data flows in the X and Y dimensions, respectively. With the TSP architecture 400, functional slices interact with streams of data in a producer-consumer fashion. That is, the functional slices consume operands from streams and produce results onto a (possibly different) stream, like an assembly line operator (functional slice) and conveyor belt (stream).

Conceptually, the functional slices are fixed, and data is flowing across computational elements as shown in FIG. 4. As the data flows through the functional slice, each computational element can optionally intercept the data operands and compute a result (if the computational element comprises an arithmetic logic unit (ALU)) or move data between lanes on the network if the computational element comprises a switching element.

Streams provide a programming abstraction and are a conduit through which data flows between functional slices. Unlike GPRs, the functional slices operate on streams of parallel data flowing cast or west (horizontally) across the module. The horizontally flowing streams carrying operands intercept the vertically (northward) flowing instructions to perform a computation at a computational element on a functional slice. A compiler accurately maintains the TSP device's architectural state and uses that knowledge to ensure that instructions correctly intercept its stream operand(s).

Streams are implemented in hardware by a module-wide streaming register file.

Streams are architecturally visible and transport operands and results between functional slices. A common software pattern involves reading operand data from one or more MEM functional slices that is then subsequently consumed and operated on by a downstream arithmetic functional slice. The results of the operation are then produced onto another stream such that they can be written back to memory or passed to subsequent computational elements. For example, a Z=X+Y operation might require four instructions: Read S1, X and Read S2, Y are executed on two MEM functional slices and directed inward toward an ALU functional slice to perform the Add S1, S2, S3. Lastly, the result is stored back to memory via a Write S3, Z. The streams represent a collection of N-elements, operated upon in a SIMD manner by each functional slice.

By way of example, a TSP architecture makes several deliberate tradeoffs on the hardware-software interface, pushing the complexities associated with scheduling into the compiler. Specifically, it falls on the compiler to precisely schedule instructions to use the hardware correctly and efficiently. At times this may involve selecting one of several means by which an algorithm or meta-operation may be realized on the hardware. Removing the control complexity of dynamic instruction scheduling for multi-issue execution units allows the ICU to be relatively small, accounting for, e.g., less than 3% of the module area.

The compiler has access to, e.g., N-lane programming abstraction overlaid on a TSP architecture where each computational element in the on-chip mesh operates on a number of lanes in a SIMD manner. The multi-lane unit can be referred to as a “superlane” which is a cross-section of all the functional slices on the TSP device and the minimum granularity of computation. As such, a superlane represents the architecture's minimum vector length, minVL, of elements.

Likewise, the vertical composition of M tiles to form a functional slice produces a maximum vector length, max VL, of M×minVL elements.

The compiler has access to independent instruction queues (e.g., ICUs) on-module: (a) for westward MXM including two independent two-dimensional MAC (multiply-accumulate) arrays; (b) for westward SXM for intra-superlane and inter-lane switching by rearranging elements of vectors; (c) for westward MEM including parallel functional slices of static random-access memory (SRAM); (d) for VXM including N vector ALUs per lane; (e) for castward MEM-including parallel functional slices of SRAM; (f) for castward SXM; and (g) for castward MXM including two independent two-dimensional MAC arrays, whereas each instruction queue can issue one or more instructions per cycle and the compiler has explicit control of the program order in each instruction queue.

The compiler has access to N logical streams per lane. For example, N/2 logical streams can be used to operate on N/4 minVL per lane for moving operands or results on-chip with N/2 streams castward, and N/2 streams westward.

The compiler has access to, for example, a number of bytes of globally shared SRAM that delivers a number of bytes per lane of stream bandwidth and low-latency access to model parameters. For example, MEM can read and MXM can install a number weights into each array in a small number of operational cycles including SRAM and on-chip network transit delay.

Streams are designated by both an identifier (0, . . . , 31) and direction. For example, in(28) designates stream 28 inward, and out(24) designates stream 24 toward the outward edge of the TSP device. The direction of a stream may be designated as inward (toward the module bisection) or outward (toward the outward edge of the module), or the direction may be designated as eastward or westward, as shown in FIG. 4.

The components of a superlane are organized spatially as shown in FIG. 4. The TSP instruction set architecture (ISA) defines instructions spanning different functional areas. The partitioned global address space (PGAS) presented by the MEM functional slices provides memory semantics for vectors to be addressed from SRAM and loaded into an architecturally visible stream with a direction of dataflow toward the functional slice intending to operate on them.

The first functional area (e.g., ICU) provides explicit instruction fetching with IFetch instruction(s), and inter-slice synchronization using Sync and Notify instructions to perform module-wide barrier synchronization among participating functional slices. A repeated-NOP (no-op) instruction allows for precise cycle-by-cycle control of inter-instruction delay. For example, the compiler has cycle-accurate control when scheduling two operations A and B using an intervening NOP so that N cycles separate them, e.g., OpA NOP(N) OpB.

The second functional area (e.g., VXM) consists of a 4×4 mesh of ALUs in each lane for point-wise arithmetic operations.

The third functional area (e.g., MXM) consists of four independent two-dimensional MAC arrays that operate on, e.g., INT8 or FP16 data types.

On-chip data movement uses the fourth functional area (e.g., SXM) for intra-superlane and inter-lane switching by rearranging elements of vectors. The SXM is analogous to an interface to communicate between cores. Together the MEM and SXM work in tandem to form the X-Y dimensions of the on-chip network.

The fifth functional area (e.g., the east and west hemisphere of on-chip MEM module) is composed of 44 parallel MEM functional slices of SRAM and provides the memory access concurrency necessary to fully utilize the 32 streams in each East or West direction. Each functional slice provides a number of bits of physical addressing of multi-byte memory words, each byte maps to a lane, for a total amount of on-chip SRAM.

An additional sixth functional area includes C2C modules configured to provide Send and Receive primitives for exchanging multi-byte vectors between a pair of TSP devices. One possible TSP implementation has, e.g., a total of 16×4 channels operating at 30 Gbps each for a total off-chip bandwidth of 16×4×30 Gbps×2 directions=3.84 Tb/s (Terabits per second) of off-chip pin bandwidth that can be flexibly partitioned to support high-radix interconnection networks of TSPs for large-scale systems. The host interface for peripheral component interconnect express (PCIe) Gen4 may be also handled in this module. The host interface provides a lightweight direct memory access (DMA) engine to emplace a model onto the TSP memory and provides an entry point for bootstrapping the model execution.

The host interface also provides a general mechanism for passing interrupts to the host, which may be necessary in the event a multi-bit memory error is observed, for example. A sequence of instructions performed on different functional slices can be chained to create more complex actions without the need to write back intermediate results to memory. This allows efficient processing of streams at full bandwidth and lowest latency.

Machine learning algorithms typically operate on vectors with coefficients of a specified data type (e.g., INT8, FP16, etc.). These vectors may be interpreted as an abstraction over the underlying data, whose elements can be processed by the same operation in a SIMD manner. The TSP operates on vectors, sometimes organized into rank-2 tensors, and relies on the graph-lowering compiler to transform higher rank tensors into rank-2 tensors.

The TSP's programming model is a producer-consumer model where each functional slice acts as a consumer and a producer of one or more streams. When a vector is read from a main memory, the vector is given a stream identifier (0, . . . , 31) and direction: castward, or westward. Once the vector is read into a stream register it is a stream and is “flowing” in the given direction in the following sense given spatially adjacent functional slices at coordinates xo, x1, x2 (where the spatial coordinate increases in the direction of flow), then at a given time ti, the vector representing stream s1 at functional slice x1 can be accessed as operands by that functional slice. Similarly, the functional slices at x0 and x2 will have access to different stream values for the same stream register. In the following cycle tH1, the value s1 either propagated to the functional slice at x2, or else the value s1 is overwritten with a result n produced by the functional slice at x1 at cycle t. Similarly, the stream value that was present to be consumed by the functional slice at coordinate x0 at time ti will be (absent xo overwriting the value at time ti) available in the next cycle tH1 to the functional slice at xi. Stream operands are steered toward the functional slice that is consuming them and producing a result stream. Streams are constantly flowing across the module, serving as the method by which functional slices communicate with one another.

In the TSP programming model, an instruction is issued on a functional slice at a given compiler-scheduled time t and executes as a SIMD operation on stream-supplied operand vectors (e.g., of up to 320-elements), producing vectors of the same length on result streams. For example, at the micro-architectural level, the 320-element SIMD instruction is pipelined across the vertical stack of computational elements in the functional slice. That is, at the scheduled time t, the instruction would be issued to the bottom-most computational element of the functional slice, e.g., corresponding to the first 16-element superlane of operand/result vectors. In the subsequent operational cycle, the instruction would be propagated to the next computational element northward in the functional slice, which in turn executes the instruction on the next 16-element super lane of operand vectors. This process continues cycle-by-cycle until the process has traversed, e.g., all 20 computational elements in the functional slice. The combination of vertical instruction pipelining described above, along with the need for operands and instructions to coincide at a precise time, results in a spatial “stagger” of SIMD operand and result data.

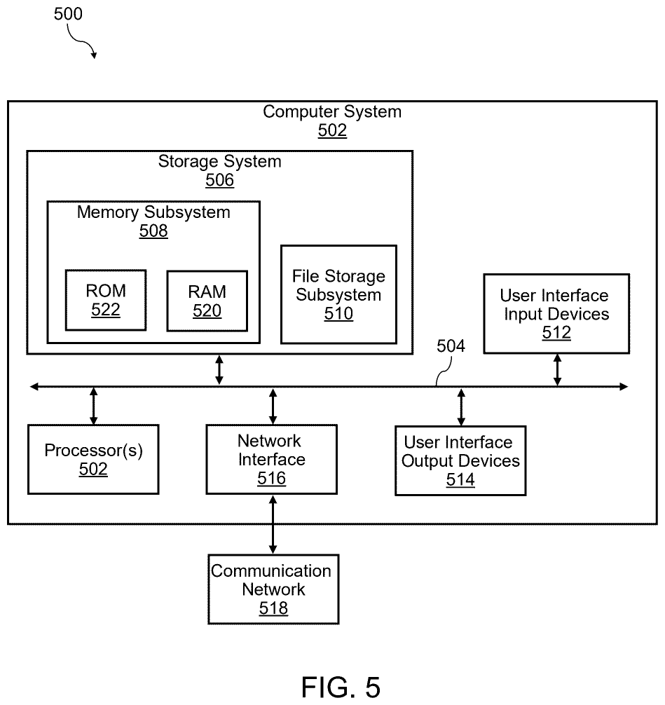

In FIG. 5, the structure of the computer system 500 typically includes at least one computer 502 which communicates with peripheral devices via bus subsystem 504. Typically, the computer includes a processor (e.g., a microprocessor, graphics processing unit, AI co-processor or digital signal processor), or its electronic processing equivalents, such as an Application Specific Integrated Circuit (‘ASIC’) or Field Programmable Gate Array (‘FPGA’). Typically, peripheral devices include a storage subsystem 506, comprising a memory subsystem 508 and a file storage subsystem 510, user interface input devices 512, user interface output devices 514, and/or a network interface subsystem 516. The input and output devices enable direct and remote user interaction with computer system 500. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program. The computer system typically includes a Basic Input/Output System (BIOS) and processor firmware. The operating system, BIOS and firmware are used by the processor to structure and control any subsystems and interfaces connected to the processor. Any embodiment of the subject disclosure is limited neither to an electronic digital logic computer structured with programs nor to an electronically programmable device. For example, the various embodiments can use an optical computer, a quantum computer, an analog computer, or the like. In other embodiments, a computing machine such as a tensor streaming processor designed and manufactured by Groq, Inc. can be utilized. Further, where only a single computer system or a single machine is signified, the use of a singular form of such terms also can signify any structure of computer systems or machines that individually or jointly use processes. Due to the ever-changing nature of computers and networks, the description of computer system 500 depicted in FIG. 5 is intended only as an example. Many other structures of computer system 500 have more components than the computer system depicted in FIG. 5.

Network interface subsystem 516 provides an interface to outside networks, including an interface to communication network 518, and is coupled via the communication network 518 to corresponding interface devices in other computer systems or machines. Communication network 518 can comprise many interconnected computer systems, machines, and physical communication connections (signified by ‘channels’). These communication channels can be wireline channels, optical channels, wireless channels (e.g., using the Wi-Fi or Bluetooth protocols), or any other physical devices for communication of information. Communication network 518 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or Integrated Services Digital Network (ISDN)), (asynchronous) digital subscriber line (DSL) unit, Firewire interface, universal serial bus (USB) interface, and the like. Communication algorithms (‘protocols’) can be specified using one or communication languages, such as Hypertext Transfer Protocol (HTTP), Transmission Control Protocol/Internet Protocol (TCP/IP), Real-time Transport Protocol/Real Time Streaming Protocol (RTP/RTSP), Internetwork Packet Exchange (IPX) protocol and/or User Datagram Protocol (UDP).

User interface input devices 512 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 500 or onto communication network 518. User interface input devices typically enable a user to select objects, icons, text and the like that appear on some types of user interface output devices, for example, a display subsystem.

User interface output devices 514 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem can also provide non-visual stimuli such as via audio output, aroma generation, or tactile/haptic output (e.g., vibrations and forces) devices. Typically, the term ‘output device’ signifies all possible types of devices and processes to transfer data and information out of computer system 500 to the user or to another machine or computer system.

Such devices are connected by wire or wirelessly to a computer system. Note that some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 508 typically includes several memories including a main random-access memory (‘RAM’) 520 (or other volatile storage device) for storage of instructions and data during program execution and a read only memory (‘ROM’) 522 in which fixed instructions are stored. File storage subsystem 510 provides persistent storage for program and data files, and can include a hard disk drive, a floppy disk drive along with associated removable media, a CD-ROM drive, an optical drive, a flash memory such as a USB drive, or removable media cartridges. If computer system 500 includes an input device that performs optical character recognition, then text and symbols printed on a physical object (such as paper) can be used as a device for storage of program and data files. The databases and modules used by some embodiments can be stored by file storage subsystem 510.

Bus subsystem 504 provides a device for transmitting data and information between the various components and subsystems of computer system 500. Although bus subsystem 504 is depicted as a single bus, alternative embodiments of the bus subsystem can use multiple buses. For example, a main memory using RAM can communicate directly with file storage systems using DMA systems.

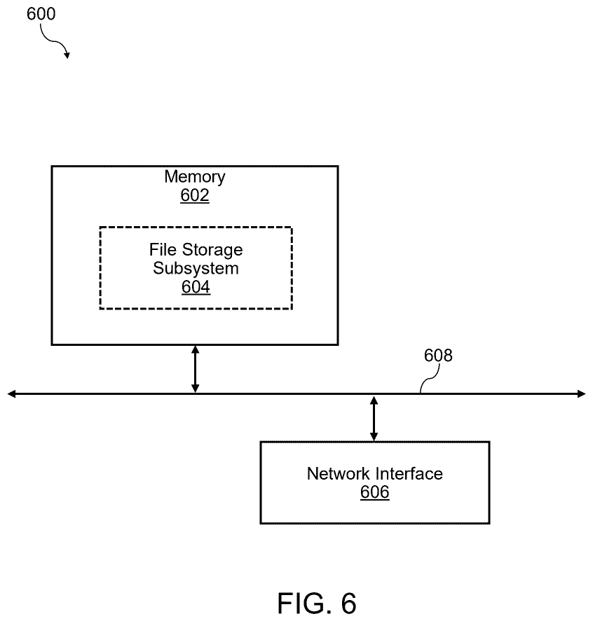

FIG. 6 depicts a memory 602 such as a non-transitory, processor readable data and information storage medium associated with file storage subsystem 604 (e.g., file storage subsystem 506), and/or with network interface subsystem 606 (e.g., network interface subsystem 516) and can include a data structure specifying a circuit design. The components of FIG. 6 can be communicatively coupled via a bus 608.

The memory 602 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program or data transferred into and out of a processor from a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

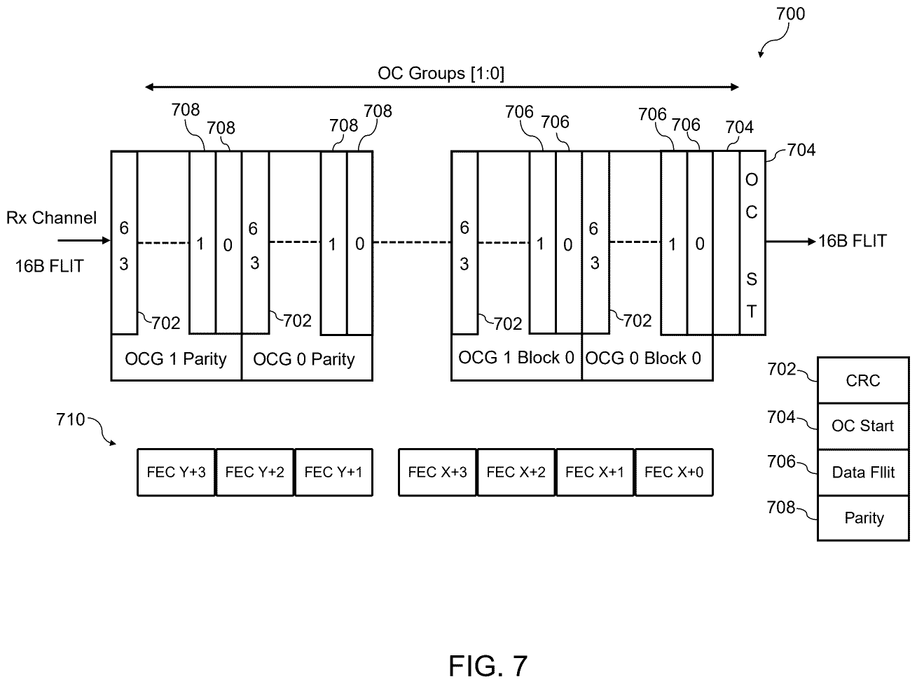

FIG. 7 illustrates an example network 700 that includes two Orthogonal Coding (OC) Groups [1:0], in accordance with some embodiments. Cyclic Redundancy Check (CRC) is indicated at boxes 702. OC start is indicated at boxes 704. Data Flit is indicated at boxes 706. Parity is indicated at boxes 708.

The network 700 includes one or more FEC blocks 710. The FEC block 710 can be an IP error correction block. The FEC block(s) 710 can have a dimensionality of 544 by 514. For example, the FEC block(s) 710 can provide for correction of a total number of 544 symbols that are 10 bits individually, for a total of 5,440 bits. The 5,440 bits, at 8 bits/byte can be 680 bytes and, at 16 bytes/flit, can be 42.5 flits. The FEC blocks 710 can provide for a total number of 514 data payload of 10b symbols, for a total of 5,140 bits. The 5,140 bits, at 8 bits/byte can be=642.5 bytes and, at 16 bytes/flit, can be 40.1 flits. A flit 706, can for example, be 128 bits or 16 bytes, representing a flow control unit. A packet can be defined by start and end control bytes. In some implementations, a payload packet can have 21 flits. The OC block can have a fixed number of flits, such as a number of flits that is equal to the block size of the FEC block(s) 710 and/or can be independent of a block size of the FEC block(s). An OC group can be defined as a group of OC blocks 704 and one parity block 708. A parity block 708 can be a same size as an OC block 704. The parity block 708 can be generated on a transmit side and verified by the receive side. For instance, the parity block 708 can define bit parity for an OC group for corresponding bit positions in OC Blocks 704. As one example, the parity can be bit 0 of flit 0 in each OC block 704.

One example receiver-side flow includes buffering all flits and delivering corrected flits in order. In some implementations, the ICU can “pop” in order. Another example receiver-side flow includes storing good flits in TSP memory followed by corrected flits. Another example receiver-side flow includes storing flits in order and subsequently popping all flits. Corrected flits can overwrite corrupted flits. Additionally or alternatively, the ICU can pop only corrected flits.

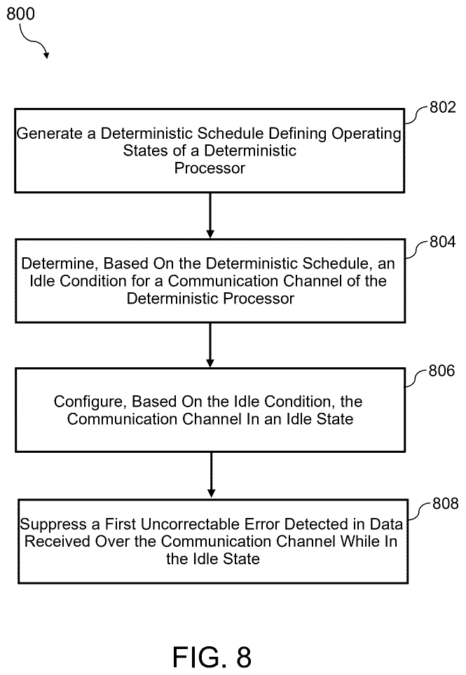

FIG. 8 depicts a flowchart diagram of an example method 800 for idle channel marking. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

The method 800 can include, at 802, generating a deterministic schedule defining operating states of a deterministic processor. The deterministic processor can be or can include, for example, the systems discussed with respect to FIGS. 1-7. As one example, the deterministic processor can be a tensor streaming processor (TSP). The deterministic schedule can define a plurality of operating states respective to a plurality of functional units of the deterministic processor. Additionally and/or alternatively, the deterministic schedule can define operating states of the deterministic processor over a plurality of timestamps. For example, the deterministic schedule can define, for each functional unit of the processor, a series of operating states that collectively cause the processor to implement a computational operation such as, for example, implementing a machine-learned model, or other suitable operation.

The method 800 can include, at 804, determining, based on the deterministic schedule, an idle condition for a communication channel of the deterministic processor. For instance, the communication channel can be configured to transmit data between a first functional unit of the plurality of functional units and a second functional unit of the plurality of functional units. During some cycles or timestamps of the deterministic schedule, the communication channel may be unused by the compiled program, but may still be electrically active.

The method 800 can include, at 806, configuring, based on the idle condition, the communication channel in an idle state. For example, the communication channel can be configured in an idle state by communicating a configuration signal to controllers at the communication channel. As one example, configuring the communication channel in an idle state can include assigning the communication channel to the idle state by an instruction control unit (ICU) of the deterministic processor.

The method 800 can include, at 808, suppressing a first uncorrectable error detected in data received over the communication channel while in the idle state. For instance, suppressing the first uncorrectable error detected in data received over the communication channel while in the idle state can include detecting the first uncorrectable error by forward error correction (FEC). The error may simply be ignored. For example, a correction action may not be triggered by the controller in response to detecting the first uncorrectable error.

The data received over the communication channel can include any suitable data. As one example, the data can include one of a no operation (NO-OP) packet, an orthogonal coding (OC) packet, a hardware adjusted clock (HAC) packet, a fault packet, a control state register (CSR) packet, or a data packet. In some implementations described herein, the processor can be configured such that even critical packets such as fault packets are accounted for by other mechanisms in the processor when the communication channel is in an idle state.

Additionally and/or alternatively, in some implementations, determining the idle condition for the communication channel is performed at a first timestamp of the plurality of timestamps. At a second timestamp of the plurality of timestamps, the communication channel can be returned to an active state (e.g., to transmit meaningful data). As examples, the method 800 can optionally further include determining, based on the deterministic schedule, an active condition for the communication channel at a second timestamp of the plurality of timestamps; configuring, based on the active condition, the communication channel in an active state; detecting a second uncorrectable error in data received over the communication channel while in the active state; and responsive to detecting the second uncorrectable error, initiating a correction action in the deterministic processor. The correction action can be any suitable action, such as restarting the deterministic processor, causing retransmission of the data, repeating a higher level computation by one or more computation steps corresponding to the corrupted data's position, or other suitable actions. The communication channel may be configured in an active state in a similar manner to how the communication channel is configured in an idle state (e.g., by a controller, such as the ICU).

In some implementations, the present disclosure provides a method. The method can include generating a deterministic schedule defining operating states of a deterministic processor. The method can include determining, based on the deterministic schedule, an idle condition for a communication channel of the deterministic processor. The method can include configuring, based on the idle condition, the communication channel in an idle state.

In some implementations, the method can further include suppressing a first uncorrectable error detected in data received over the communication channel while in the idle state.

In some implementations, the deterministic schedule defines a plurality of operating states respective to a plurality of functional units of the deterministic processor.

In some implementations, the communication channel is configured to transmit data between a first functional unit of the plurality of functional units and a second functional unit of the plurality of functional units.

In some implementations, the deterministic schedule defines operating states of the deterministic processor over a plurality of cycles.

In some implementations, determining the idle condition for the communication channel is performed at a first timestamp of the plurality of timestamps.

In some implementations, the method further includes: determining, based on the deterministic schedule, an active condition for the communication channel at a second timestamp of the plurality of timestamps; configuring, based on the active condition, the communication channel in an active state; detecting a second uncorrectable error in data received over the communication channel while in the active state; and responsive to detecting the second uncorrectable error, initiating a correction action in the deterministic processor.

In some implementations, the correction action comprises restarting the deterministic processor.

In some implementations, configuring the communication channel in an idle state comprises assigning the communication channel to the idle state by an instruction control unit (ICU) of the deterministic processor.

In some implementations, the data received over the communication channel comprises one of a no operation (NO-OP) packet, an orthogonal coding (OC) packet, a hardware adjusted clock (HAC) packet, a fault packet, a control state register (CSR) packet, or a data packet.

In some implementations, suppressing the first uncorrectable error detected in data received over the communication channel while in the idle state comprises detecting the first uncorrectable error by one of forward error correction (FEC), orthogonal coding (OC), or checksumming.

In some implementations, the deterministic processor comprises a tensor streaming processor (TSP).

In some implementations, the present disclosure provides a computing system. The computing system can include one or more processors and one or more non-transitory, computer-readable media storing instructions that, when implemented, cause the one or more processors to perform. The operations can include generating a deterministic schedule defining operating states of a deterministic processor. The operations can include determining, based on the deterministic schedule, an idle condition for a communication channel of the deterministic processor. The operations can include configuring, based on the idle condition, the communication channel in an idle state.

In some implementations, the operations can further include suppressing a first uncorrectable error detected in data received over the communication channel while in the idle state.

In some implementations, the deterministic schedule defines a plurality of operating states respective to a plurality of functional units of the deterministic processor.

In some implementations, the communication channel is configured to transmit data between a first functional unit of the plurality of functional units and a second functional unit of the plurality of functional units.

In some implementations, the deterministic schedule defines operating states of the deterministic processor over a plurality of timestamps.

In some implementations, determining the idle condition for the communication channel is performed at a first timestamp of the plurality of timestamps.

In some implementations, the operations further include: determining, based on the deterministic schedule, an active condition for the communication channel at a second timestamp of the plurality of timestamps; configuring, based on the active condition, the communication channel in an active state; detecting a second uncorrectable error in data received over the communication channel while in the active state; and responsive to detecting the second uncorrectable error, initiating a correction action in the deterministic processor.

In some implementations, the correction action comprises restarting the deterministic processor.

In some implementations, configuring the communication channel in an idle state comprises assigning the communication channel to the idle state by an instruction control unit (ICU) of the deterministic processor.

In some implementations, the data received over the communication channel comprises one of a no operation (NO-OP) packet, an orthogonal coding (OC) packet, a hardware adjusted clock (HAC) packet, a fault packet, a control state register (CSR) packet, or a data packet.

In some implementations, suppressing the first uncorrectable error detected in data received over the communication channel while in the idle state comprises detecting the first uncorrectable error by one of forward error correction (FEC), orthogonal coding (OC), or checksumming.

In some implementations, the present disclosure provides one or more non-transitory, computer-readable media storing instructions that, when implemented, cause one or more processors to perform. The operations can include generating a deterministic schedule defining operating states of a deterministic processor. The operations can include determining, based on the deterministic schedule, an idle condition for a communication channel of the deterministic processor. The operations can include configuring, based on the idle condition, the communication channel in an idle state.

In some implementations, the operations can further include suppressing a first uncorrectable error detected in data received over the communication channel while in the idle state.

Additionally, the present disclosure provides a system for speculative decoding according to any of the aspects described herein.

Additionally, the present disclosure provides a method for speculative decoding according to any of the aspects described herein.

Additionally, the present disclosure provides an apparatus for speculative decoding according to any of the aspects described herein.

Additionally, the present disclosure provides one or more non-transitory, computer-readable media storing instructions that, when implemented, cause one or more processors to perform operations comprising any of the aspects described herein.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method, comprising:
generating a deterministic schedule defining operating states of a deterministic processor;
determining, based on the deterministic schedule, an idle condition for a communication channel of the deterministic processor; and
configuring, based on the idle condition, the communication channel in an idle state.

2. The method of claim 1, wherein the deterministic schedule defines a plurality of operating states respective to a plurality of functional units of the deterministic processor.

3. The method of claim 2, wherein the communication channel is configured to transmit data between a first functional unit of the plurality of functional units and a second functional unit of the plurality of functional units.

4. The method of claim 1, wherein the deterministic schedule defines operating states of the deterministic processor over a plurality of cycles.

5. The method of claim 4, wherein determining the idle condition for the communication channel is performed at a first timestamp of the plurality of timestamps; and
wherein the method further comprises:
determining, based on the deterministic schedule, an active condition for the communication channel at a second timestamp of the plurality of timestamps;
configuring, based on the active condition, the communication channel in an active state;
detecting a second uncorrectable error in data received over the communication channel while in the active state; and
responsive to detecting the second uncorrectable error, initiating a correction action in the deterministic processor.

6. The method of claim 1, further comprising suppressing a first uncorrectable error detected in data received over the communication channel while in the idle state.

7. The method of claim 1, wherein configuring the communication channel in an idle state comprises assigning the communication channel to the idle state by an instruction control unit (ICU) of the deterministic processor.

8. The method of claim 1, wherein the data received over the communication channel comprises one of a no operation (NO-OP) packet, an orthogonal coding (OC) packet, a hardware adjusted clock (HAC) packet, a fault packet, a control state register (CSR) packet, or a data packet.

9. The method of claim 1, wherein suppressing the first uncorrectable error detected in data received over the communication channel while in the idle state comprises detecting the first uncorrectable error by one of forward error correction (FEC), orthogonal coding (OC), or checksumming.

10. The method of claim 1, wherein the deterministic processor comprises a tensor streaming processor (TSP).

11. A computing system, comprising:
one or more processors; and
one or more non-transitory, computer-readable media storing instructions that, when implemented, cause the one or more processors to perform operations comprising:
generating a deterministic schedule defining operating states of a deterministic processor;
determining, based on the deterministic schedule, an idle condition for a communication channel of the deterministic processor; and
configuring, based on the idle condition, the communication channel in an idle state.

12. The computing system of claim 11, wherein the deterministic schedule defines a plurality of operating states respective to a plurality of functional units of the deterministic processor.

13. The computing system of claim 12, wherein the communication channel is configured to transmit data between a first functional unit of the plurality of functional units and a second functional unit of the plurality of functional units.

14. The computing system of claim 11, wherein the deterministic schedule defines operating states of the deterministic processor over a plurality of timestamps.

15. The computing system of claim 14, wherein determining the idle condition for the communication channel is performed at a first timestamp of the plurality of timestamps; and
wherein the operations further comprise:
determining, based on the deterministic schedule, an active condition for the communication channel at a second timestamp of the plurality of timestamps;
configuring, based on the active condition, the communication channel in an active state;
detecting a second uncorrectable error in data received over the communication channel while in the active state; and
responsive to detecting the second uncorrectable error, initiating a correction action in the deterministic processor.

16. The computing system of claim 15, wherein the operations further comprise suppressing a first uncorrectable error detected in data received over the communication channel while in the idle state.

17. The computing system of claim 11, wherein configuring the communication channel in an idle state comprises assigning the communication channel to the idle state by an instruction control unit (ICU) of the deterministic processor.

18. The computing system of claim 11, wherein the data received over the communication channel comprises one of a no operation (NO-OP) packet, an orthogonal coding (OC) packet, a hardware adjusted clock (HAC) packet, a fault packet, a control state register (CSR) packet, or a data packet.

19. The computing system of claim 11, wherein suppressing the first uncorrectable error detected in data received over the communication channel while in the idle state comprises detecting the first uncorrectable error by one of forward error correction (FEC), orthogonal coding (OC), or checksumming.

20. One or more non-transitory, computer-readable media storing instructions that, when implemented, cause one or more processors to perform operations comprising:
generating a deterministic schedule defining operating states of a deterministic processor;
determining, based on the deterministic schedule, an idle condition for a communication channel of the deterministic processor;
configuring, based on the idle condition, the communication channel in an idle state.
